(19) United States
(12) Patent Application Publication
(10) Pub. No.: US 2002/0078151 A1
(43) Pub. Date: Jun. 20, 2002

(54) System for communicating messages of various formats between diverse communication devices

(76) Inventors: Bryce C. Wickam, Newark, CA (US); Richard J. Huetteman, Hillsborough, CA (US)

Correspondence Address: MARK A LAUER, 7041 KOLL CENTER PARKWAY, SUITE 280, PLEASANTON, CA, 94566, US

(21) Appl. No.: 09/739,523

(22) Filed: Dec. 15, 2000

(51) Int. Cl. G06F 15/16

(52) U.S. Cl. 709/204

(57) ABSTRACT

A system for transmitting a wide variety of communications between a wide variety of end user devices via IP networks, including delivering voice quality calls over IP networks between conventional telephones. The system allows end users to change or augment the format for communication, for example between email, chat, voice and video, by simply selecting an icon or button. The communications may also be redirected between the various end user devices and to a message storage center that can store the message in a variety of formats, providing various messaging options. One or more packet managers that receive, transmit and process digital signals control the various communications, providing for users a seamless communication experience traversing the PSTN and IP networks.

### MICROFICHE APPENDIX

A Microfiche Appendix is included herewith, the Appendix containing computer program code.

### COPYRIGHT NOTICE

A portion of the disclosure of this patent document contains material that is subject to copyright protection. The copyright owner has no objection to the reproduction of the patent document or the patent disclosure in exactly the form it appears in the Patent and Trademark Office patent file or records, but otherwise reserves all copyright rights whatsoever.

### BACKGROUND

The present invention relates to communication systems, such as telecommunication networks, data networks, and the Internet, and to message transfer over such systems.

Telephone systems have traditionally set up a fixed connection path at the outset of a call on between individual telephones over a telecommunications network such as the public switched telephone network (PSTN). The fixed path may include plural transmission lines that are connected by plural switches, the switches locked in place for the duration of the call to hold the path for the use of those individual telephones for that duration. In addition to ensuring that communication between users of the phones can occur while the phones are connected, such a fixed path also makes delays in hearing the voice from the other end typically imperceptible, even for the situation in which the path is several thousand kilometers or more in length. Telephone systems such as the PSTN also traditionally have employed analog signals that are created by a microphone in the phone of a user that is speaking and interpreted by a speaker in the phone a user that is listening.

Although the analog PSTN lets people located in different states or nations sound like they are next door, a disadvantage with this system is an inefficient use of bandwidth for the fixed path. Analogous to this fixed path is a highway that only allows one car to travel at a time, until the car has reached its destination. During pauses in speech the allocated bandwidth is entirely wasted, and during times when only one side is speaking half the bandwidth may be wasted. To reduce this waste of bandwidth, multiple analog conversations can be transmitted over such lines and switches with frequency division multiplexing (FDM). On the other hand, point-to-point dedicated, digital circuits that ensure high bandwidth, such as T-1 and T-3 lines, may employ time division multiplexing (TDM) to interleave a number of voice or data channels, with unused bandwidth wasted.

Data networks have traditionally offered variable paths for communications between individual computers connected to the networks. Data, such as a digital file that is to be transferred between the computers, is divided into packets that each are affixed with control information such as the addresses of the sending and receiving computers. When the packets are transmitted to a local network by the sending computer, they may be routed through various networks according to their addresses to eventually arrive at the receiving computer. In order to use networks and routers more efficiently, different packets from the same file transfer may be routed over very different paths, especially when the packets are transferred over the Internet. Thus the packets from a file being transferred may arrive at different times or in a different order than that with which they were sent, or in bursts, while some packets may not arrive at all and need to be resent.

Individual routers that are designed for data networks can be programmed to operate in a fast switching mode as opposed to a process switching mode, so that after a router has sent a first packet for a message to a next hop router, subsequent packets for the same message are sent to the same next hop router. While this may be beneficial for packets that need to be sent as quickly as possible, the efficiency of those routers is diminished for data messages, since the opportunity to choose a low cost route is lost. A message sent over the Internet, which may pass through many routers before delivery, may encounter routers operating in the fast switching mode as well as routers operating in the more common, process switching mode.

Internet protocol (IP), the most common internet layer protocol used on data networks such as the Internet, is connectionless. Without dedicated connections, IP only uses bandwidth when sending packets containing data. Transport control protocol (TCP), which runs over IP, provides a reliable connection only via end-user activities, such as checking that all data has been received, requesting retransmission of missing packets and rearranging packets into the correct order. Thus voice over TCP suffers from delays in receiving messages, as the data may need to be retransmitted and/or rearranged before being available to an end user.

User datagram protocol (UDP), which can also run over IP, is a connectionless transport layer protocol. Thus there may not be long delays while processing a message, but the message may not all be received. Further, the packets may be received out of order due to varying paths over the Internet, so that message quality may be low. These problems may be exacerbated with video, which has more data packets and requires more bandwidth.

Asynchronous Transfer Mode (ATM) packet switching networks use switches that establish a logical circuit from end to end, which guarantees a quality of service (QOS) for that transmission. However, unlike telephone switches that dedicate circuits end to end, unused bandwidth in ATM's logical circuits can be appropriated whenever available. For example, idle bandwidth in a videoconference circuit can be used to transfer data. ATM works by transmitting all traffic as fixed-length, 53-byte cells. This fixed unit allows very fast switches to be built, because it is much faster to process a known packet size than to determine the start and end of variable length packets. The small ATM packet also ensures that voice and video can be inserted into the stream often enough for real-time transmission. Most networks do not have ATM capabilities, however, and conversion between IP packets and ATM packets can more than negate ATMs advantages.

Frame relay protocol, runs over ATM networks, provides permanent and switched logical connections. A Permanent Virtual Circuit (PVC) is a logical connection that is provisioned ahead of time, while a Switched Virtual Circuit (SVC) is a logical connection provisioned on demand. The connections are identified by a Data Link Connection Identifier (DLCI) number that is significant to the local frame relay switch, which will change the number as it passes the packet on to its destination, because the receiving switch uses a different DLCI for its end of the same connection. Every DLCI requires a Committed Information Rate (CIR), which is a pledge on the part of the network to provide a certain amount of transmission capacity for the connection. Voice over frame relay enables voice to be packetized and travel over a frame relay network, but suffers from the need for IP translation, may be too slow when implemented as a SVC and too limited when implemented as a PVC.

Realtime transport protocol (RTP) is a protocol that runs over IP and supports “realtime” transmission of voice and video. An RTP packet rides on top of UDP and includes timestamping and synchronization information in its header for proper reassembly at the receiving end. Realtime transport control protocol (RTCP) is a companion protocol that is used to maintain QOS. RTP nodes analyze network conditions and periodically send each other RTCP packets that report on network congestion.

Variations in packet reception may not be harmful for file transfers that are not urgent, such as TCP packets that can be rearranged into the correct order by the receiving computer, with missing or damaged packets retransmitted within a few minutes. Such delays and variations, however, are not tolerable for realtime voice or video communications. Even for the situation in which no packets are lost or out of order, bursts of received packets or variations in the Internet paths taken by digital voice packets may cause the packets to be received with a different timing than that with which they were sent, resulting in “jitter” that is heard by the listener. In general, human perception sets limits on the quality of such communications, such that errors that are imperceptible are generally tolerable, while those that are perceptible are not. For instance, people generally cannot detect delays in speech that are less than about 150 milliseconds, so that a telecommunications system that has a one-way delay of less than that amount, and lacks other perceptible errors, may be said to be “voice quality.”

FIG. 1 provides a diagram of prior art communication systems including a pair of telephones 20 and 22 that may be connected via local exchange carrier (LEC) 25 and LEC 28 via the PSTN 30. LECs 25 and 28 may for example be local telephone companies such as regional Bell Operating Companies, and may each include a switch that maintains a connection with the PSTN 30, which also maintains a fixed path for the duration of a call between telephones 20 and 22. Personal computer (PC) 33 and PC 35 can also be connected to LECs 25 and 28, sending and receiving analog signals that are directed to gateway routers 37 and 39, for conversion to digital packets that are routed over the Internet 40. In this case communications between PCs 33 and 35 are sent as IP packets that may traverse the Internet over variable paths.

It is also possible to send messages from PC 33 to telephone 22 over the Internet 40, or from PC 33 to telephone 22 over the Internet 40. PCs 33 and 35 may in this case each be equipped with a microphone that turns sound into analog electrical signals, the analog signals then being converted to digital signals by the PC. For the situation in which the PC is connected to an analog LEC line, the digital signals may again be converted back into analog signals, which are directed to a gateway router that converts the signals back into digital packets for transfer over the Internet 40. Due to the variable paths that packets may take over the Internet, the voice quality may be very poor. For example, an average packet sent via the Internet from one coast of the U.S. to the other in 1999 may have encountered more than twenty routers, each of which adds delay and may send the packet to a different node than related packets.

On the other hand, telephones 42 and 44 are equipped with specialized jitter buffers 46 and 48, respectively, that include mechanisms for rearranging the timing of received packets to correspond to the timing with which those packets were transmitted. Since rearranging the timing of the packets adds to the overall delay, a tradeoff between perceptible delays and jitter exists that has caused voice communications over the Internet to be of generally poorer quality than traditional telephone calls.

FIG. 2 shows another prior art communication system as described in U.S. Pat. No. 6,069,890, which is incorporated by reference herein. A pair of telephones 50 and 52 may be connected via LEC 55 and LEC 58, which may each include a switch that affords a connection with the PSTN, not shown in this figure. PC 53 and PC 55 can also be connected to LECs 25 and 28, sending and receiving analog signals that are directed to gateway routers 57 and 59, for conversion to digital packets that are routed over the Internet 40. In this case communications between PCs 53 and 55 are sent as IP packets that may traverse the Internet 40 over different paths.

Gateway router 57 includes an Internet address database 77 that can be used by telephone 50 to route a telephone call over the Internet 40. To do this, a user of telephone 50 dials a special number that is directed to gateway router 57, alerting that gateway router that a telephone call over the Internet is to follow. The user then dials the telephone number of telephone 52, to initiate a telephone call between phones 50 and 52, which call is also directed to gateway router 57. Internet address database 77 has a table associating various telephone numbers with Internet addresses of adjacent gateway routers. Using this table, gateway router 57 directs the number dialed to another gateway router 59 that is adjacent to an LEC 58 providing service to telephone 52, and the call is connected, assuming telephone 52 is not off-hook. Although this system is said to allow a conventional telephone to call another convention telephone via the Internet, the quality may be poor, given the delay and jitter inherent in such an Internet routed call.

Entering another special number allows telephone 50 to call PC 55 or telephone 52 to call PC 53 via the Internet 40, via a similar mechanism. Switching systems 80 and 82 are connected to LECs 55 and 58, respectively, providing switching mechanisms for telephones 72 and 75, respectively. A voice mail system 85 is connected to switching system 80 and another voice mail system 88 is connected to switching system 82. Voice mail systems 85 and 88 can store messages of various formats, such as voice, fax and text. Switching systems 80 and 82 and voice mail systems 85 and 88 all use analog signaling. While this may be adequate for adjacent telephones, the availability of voice mail system 85 to distal telephones 75, for example, may be limited.

### SUMMARY

In accordance with the present invention, voice quality calls may be transmitted over IP networks between conventional telephones. In addition, a wide variety of communications may be routed between a wide variety of end user devices via the IP networks. Users may change or augment the format for communication, for example between email, chat, voice and video, by simply selecting an icon or button. The communications may also be redirected between the various end user devices and to a message storage center that can store the message in a variety of formats, providing various messaging options. One or more packet managers that receive, transmit and process digital signals control the various communications, providing for users a seamless communication experience traversing the PSTN and IP networks.

### DESCRIPTION OF THE FIGURES

FIG. 1 provides a diagram of some prior art communication systems including a traditional telephone system and the Internet, along with a way of routing a call from a PC to a telephone over the Internet.

FIG. 2 provides a diagram of another prior art communication system including a way of routing a call from a first telephone to a second telephone over the Internet.

FIG. 3 shows a communication system 100 in accordance with the present invention, including a packet manager that controls various communications of the system.

FIG. 4 shows some components of a first packet manager of FIG. 3.

FIG. 5 shows some components of a second packet manager of FIG. 3.

FIG. 6 shows a database component of a packet manager of FIG. 4 or FIG. 5.

FIG. 7 shows a communication device displaying various communication options provided by the packet manager of FIG. 4.

FIG. 8 shows a protocol-processing stack contained in a gatekeeper of the packet manager of FIG. 4.

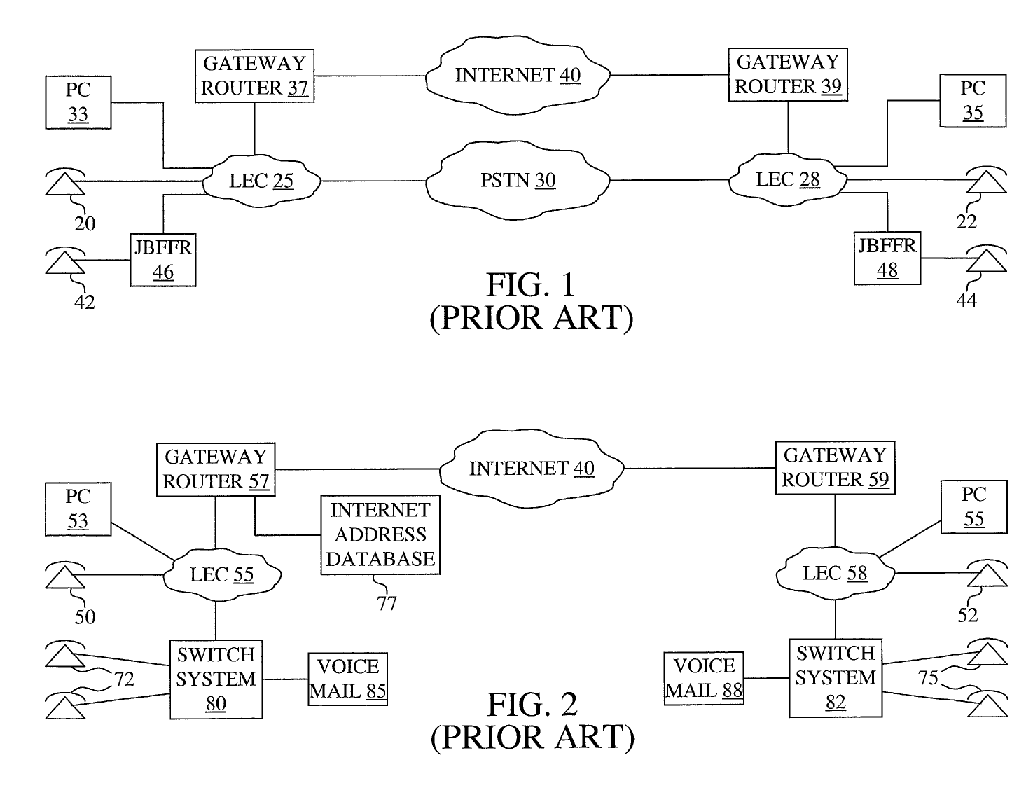

### DESCRIPTION OF THE PREFERRED EMBODIMENTS

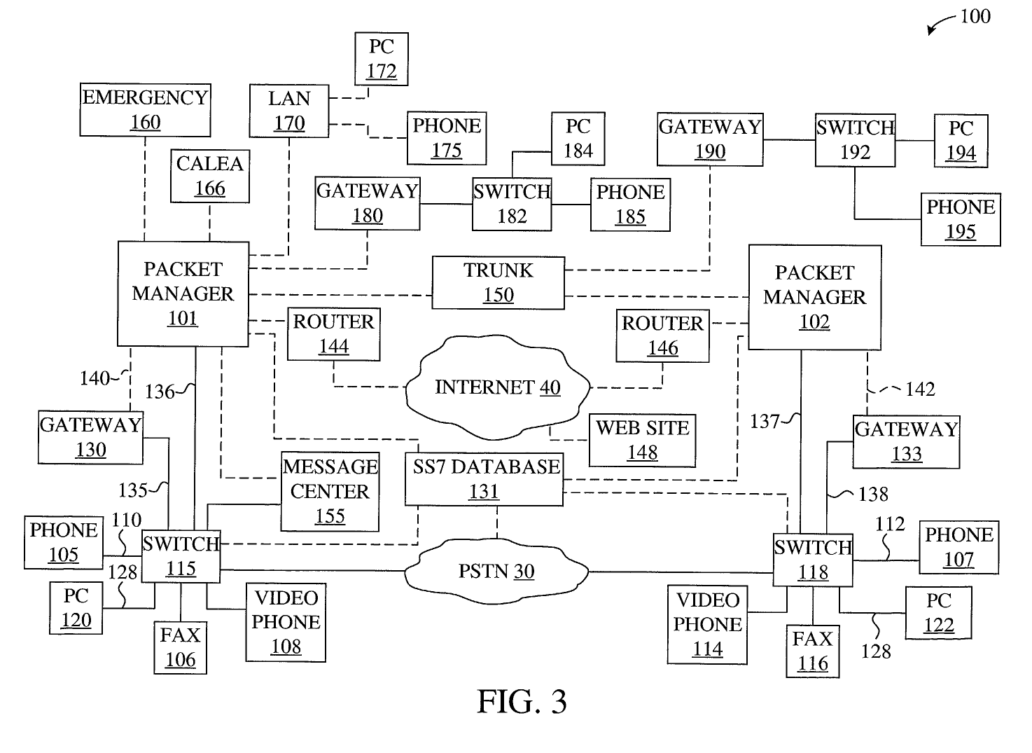

FIG. 3 shows a communication system 100 in accordance with the present invention, including a packet manager 101 that controls various communications of the system. An optional second packet manager 102 is shown that may provide additional controls for communications of this system 100 or others, not shown. First and second conventional telephones 105 and 107 are connected to conventional telephone lines 110 and 112, which are respectively connected to switches 115 and 118. Similarly, PC 120 and PC 122 are connected by conventional transmission lines 125 and 128 to switches 115 and 118, respectively. Transmission lines 110, 112, 125 and 128 may be conventional twisted pairs of copper wires or other transmission lines, such as coaxial cable or fiber optic lines, or may represent a wireless connection for example with a cellular telephone. Also connected to switch 115 are facsimile machine 106 and videophone 108, which may be connected by lines 110 and 128 or separately as shown. Similarly, facsimile machine 114 and videophone 116 are connected to switch 118. Advantageously, the present invention will work with a wide variety of devices, including common equipment such as conventional telephones and lines, without the need for upgrading or replacing existing equipment.

Switches 115 and 118 are connected to the PSTN 30 for traditional analog telephone calls, and are also connected to gateways 130 and 133 by transmission lines 135 and 138, respectively. Switches 115 and 118 also have a direct connection to packet managers 101 and 102 via transmission lines 136 and 137, respectively. Gateways 130 and 133 are coupled to packet managers 101 and 102 by transmission lines 140 and 142, respectively, and may also be coupled to the Internet 40 separately from packet managers 101 and 102, those connections not shown in this figure for clarity. Transmission lines 140 and 142 are private networks allocating sufficient bandwidth to IP packets transferred between packet managers 101 and 102 and respective gateways 130 and 133 to ensure that the latency therebetween does not exceed 30 milliseconds. Gateways 130 and 133 translate between analog signals employed by switches 115 and 118 and digital signals employed by packet managers 101 and 102. Gateways 130 and 133 may optionally be contained in respective packet managers 101 and 102. A signaling system 7 (SS7) database 131 is provided by the PSTN 30 for control functions such as connecting, routing and disconnecting telephone calls, the SS7 database accessible by packet managers 101 and 102. Transmission lines that carry primarily analog signals, such as lines 135 and 138, are shown as solid lines in this figure, whereas transmission lines that carry primarily digital signals, such as lines 140 and 142, are shown as dashed lines.

Packet managers 101 and 102 provide controls for various communications devices illustrated in FIG. 3, via signals appropriate for each such device. Although packet managers 101 and 102 operate on, send and receive digital signals, the packet managers can control analog devices such as telephones 105 and 107 via analog signals over lines such as 110 and 112, the analog signals converted from digital signals sent by the packet managers 101 and 102 to gateways 130 and 133. Stated differently, the packet managers 101 and 102 control and provide communication between various and sundry devices shown in this figure with IP protocol signals generated, received, translated and transferred by the packet managers.

Packet managers 101 and 102 are coupled to the Internet 40 via routers 144 and 146, with web site 148 coupled to or part of the Internet. As described below, conventional analog telephone 105 as well as videophone 108 or PC 120 are enabled by packet manager 101 to access web site 148. A high-speed trunk 150, which may for example include optical fibers, employ dense wave division multiplexing (DWDM) and traverse states or connect continents, directly connects packet managers 101 and 102. As described below, the combination of high-speed trunk 150 with dedicated transmission lines 140 and 144 allows packet manager 101 provide voice quality communications over a wide area IP network between conventional analog telephones 105 and 107.

Packet manager 101 is also coupled to a message center 155 that stores digital messages of various types for the various devices. Message center 155 can convert the messages from digital to analog signals and provide the analog signals via switch 115 to phone 105, fax 106, video phone 108 or PC 120, in the appropriate form for the selected device and under control of the packet manager 101. Packet manager affords various options for routing, receiving and storing communications, which may be selected after initiation of a call, such as call forwarding, call waiting, call transfer, finding a device where a person can be reached, connection of multiple parties, and connection of multiple adjacent devices.

Packet manager 101 can also provide identification and preferences to emergency services calls 160 such as 911, police or fire calls. Note that these emergency services 160 are available via conventional analog telephone 120 even if a power outage were to render specialized Internet phones useless. Since many emergencies may include a loss of power, this feature may provide a tremendous advantage to a communication system of the present invention, especially compared to competing voice over IP technologies.

In addition, packet manager 101 may be configured to provide support for the Communications Assistance for Law Enforcement Act (CALEA) 166, unlike some competing voice over IP technologies. CALEA essentially mandates that new forms of technology allow law enforcement officials to conduct authorized electronic surveillance. In accordance with the present invention, upon receiving the required authorization from a court to conduct a wiretap of telephone 105, for instance, packet manager 101 can simply copy packets headed to or from that telephone and send the copied packets to the appropriate law enforcement agency.

A local area network (LAN) 170 is also coupled to packet manager 101 in this example, with a PC 172 and telephone 175 coupled to LAN 170. Telephone 175 may be a videophone, and other devices may be coupled to LAN 170, which are not shown for clarity. In this configuration digital signals (IP packets) may be sent between devices such as PC 172 and phone 175 and LAN 170, and between LAN and packet manager 101.

Another gateway 180 is shown coupled to packet manager 101 and a PC 184, phone 185 or other devices may be connected to gateway 180 via switch 182. In this manner, voice quality communications are available between conventional analog telephones 105 and 185 via IP networks connected by packet manager 101. Gateway 190 is coupled to high-speed trunk 150 and switch 192, converting analog signals sent from switch 192 to digital signals that are directed to trunk 150 and vice-versa. PC 194 and telephone 195 are connected to switch 192, with packet manager 101 and trunk 150 affording voice quality communications over an IP network that may span or connect continents.

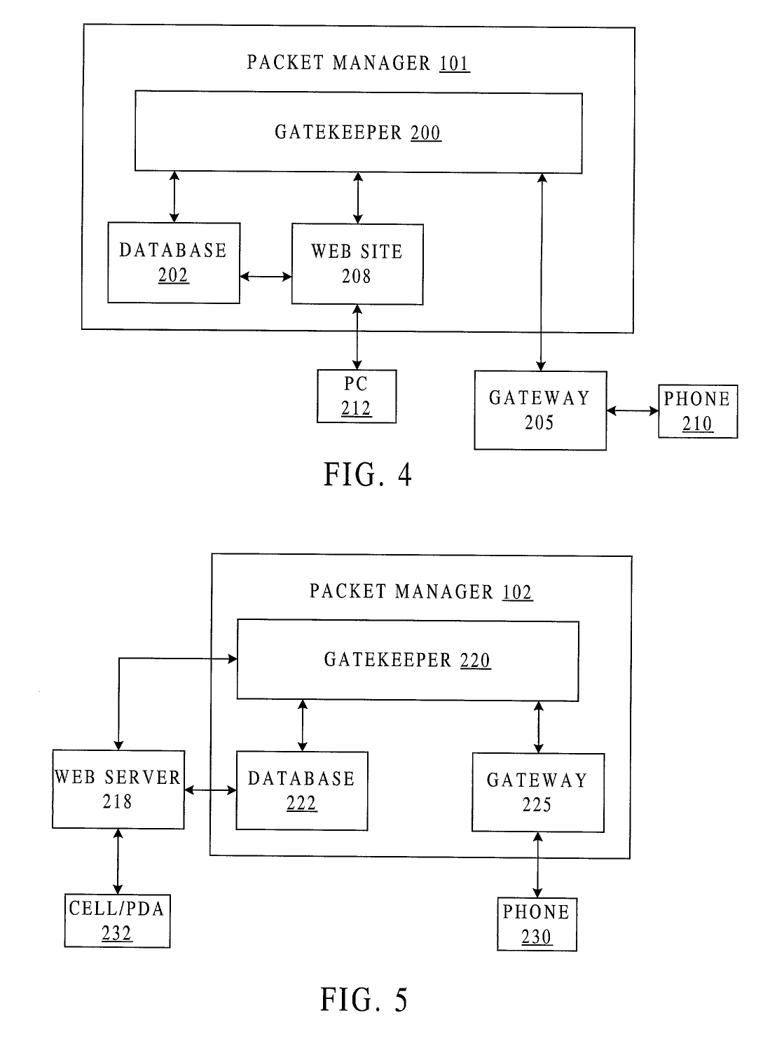

FIG. 4 shows that packet manager 101 contains a gatekeeper 200, database 202, and web site 208. Gatekeeper 200 is coupled to a gateway 205, which may be similar to gateway 130 or 133, gateway 205 in turn being coupled to a telephone 210, optionally via a switch that determines whether the phone 210 is connected to the PSTN or the packet manager 101. Web site 208 provides communications, such as hypertext markup language (HTML) or extensible markup language (XML) pages, that are interpreted by a web browser of a user interface device such as PC 212 to be accessible by a graphical user interface of such a device. PC 212 has multimedia capabilities such as a speaker, microphone, display and optional camera.

A computer program that runs packet manager 101 on a Windows® NT operating system is included in the Microfiche Appendix submitted with this application. A similar program may be used to run packet manager 101 on other operating systems, such as Unix or Linux.

The gatekeeper 200 and gateway 205 each include a processor and may be connected to each other by an Ethernet cable, with the gatekeeper serving as master and gateway as slave. The database 202 may be contained in a disk drive or plurality of disk drive, such as a redundant array of inexpensive disks (RAID) system, which may also be connected to the I/O bus or may be coupled via a network such as Ethernet. User data from database 202 is also cached in a short-term memory of gatekeeper 200 for users that are currently connected.

Gateway 205 provides conversion between analog telephone signals that may be used by telephone 210 and the PSTN 30, and digital signals used by the packet manager, including control signals and packets containing compressed voice data. Gateway 205 includes codec hardware or software that converts analog sound, speech or video to digital code (analog to digital) and vice versa (digital to analog). The gateway 205 in this embodiment provides a node for both the analog PSTN 30 and a digital IP network including the packet manager 101, the gateway 205 being connected to and controlled by gatekeeper 202. In another embodiment, packet manager 101 may contain gateway 205, instead being coupled to a gateway that communicates with other IP nodes in addition to packet manager 101.

FIG. 5 shows that packet manager 102 contains a gatekeeper 220, database 222, and gateway 225. Gateway 225 is coupled to a telephone 230, optionally via a switch that determines whether the phone 230 is connected to the PSTN or the packet manager 102. Unlike packet manager 101, packet manager 102 does not contain a web site, with a web server 218 instead being coupled to packet manager 101 by transmission lines. Web server 218 provides communications accessible by a graphical user interface of a device such as cellular telephone or PDA 232. Cell/PDA 232 includes a web browser and has multimedia capabilities such as a speaker, microphone, display and optional camera.

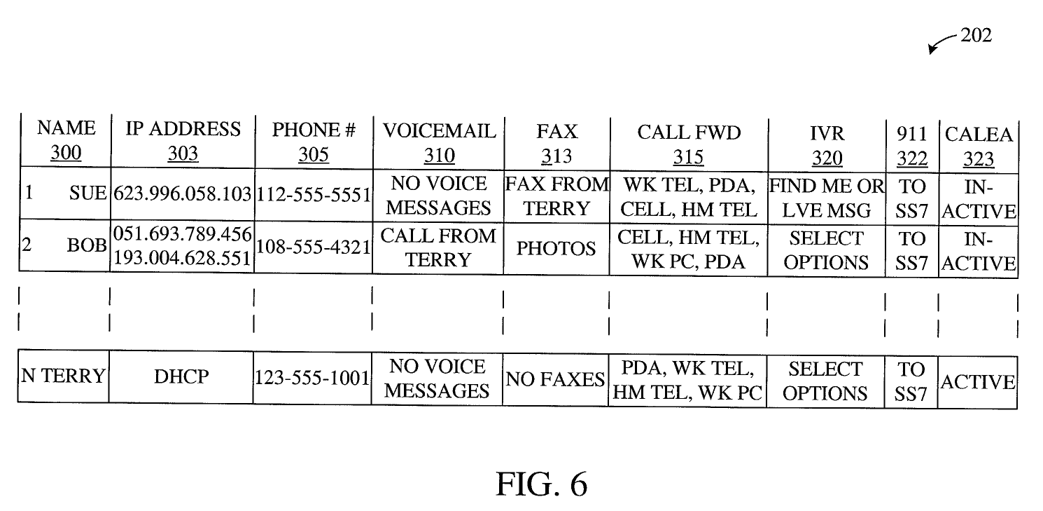

FIG. 6 shows an embodiment of database 202 with examples of data contained therein. A user name 300 or alias is shown in a first column, which in this example contains the names Sue, Bob and Terry. The database can contain information corresponding to many more users than the few that are shown for brevity. At least one IP address 303 is associated with each user name, as shown in a second column. The user name may be associated with a password or other identifier, such as a biometric identification, that restricts access to the database 202. The IP addresses 303 may be static or temporary dynamic host configuration protocol (DHCP) addresses. In the illustrated example, user name Sue has an IP address of 623.996.058.103, user name Bob corresponds to IP addresses 051.693.789.456 and 193.004.628.551, and user name Terry has a DHCP IP address assigned as needed. At least one telephone number 305 is associated with each user name, as shown in a second column. In accordance with the current invention, a user can maintain a telephone number that is available for user communication irrespective of the physical location of the user.

Voicemail messages 310 or other audio files for each user can be stored in digital form in the database 202, for example using the WAV format. The examples include a call from Terry in Bob's voicemail box, and no voice messages in Sue or Terry's voicemail box. Fax messages 313 or other image files for each user can also be stored in digital form in the database 202, for example using TIF or JPEG formats. Similarly, although not shown, database 202 can contain digital video files for a user that may be stored, for example, in MPEG format.

A call forwarding 315 capability is also included in the database 202 for each user, the call forwarding programmable according to the user's preferences. The call forwarding 315 can be set up to perform “find me” and/or “follow me” functions. In the “find me” mode, the call forwarding 315 can be programmed to sequentially connect with various devices corresponding to the user name 300 in an attempt to reach a device immediately accessible to the user. If access to the user is not successful through any device, a message can be left for the user in the voicemail box. In the “follow me” mode, the call forwarding 315 can be programmed to attempt to direct a communication initially to a communication device that was most recently used by a user, or to a device that has been preselected by the user. Thus for user name Sue, call forwarding is set up to initially try her work telephone, then her personal digital assistant (PDA), then her cellular telephone, and then her home telephone, after which a message may be stored in her voicemail box. For user name Bob, call forwarding 315 is programmed to poll Bob's cellular telephone, home telephone, work PC and PDA, while user name Terry's call forwarding 315 is programmed to poll Terry's PDA, work telephone, home telephone and work PC.

An integrated voice response (IVR) function is also included in database 202, which offers at least one prerecorded message providing callers various options on directing their call. In the example shown in FIG. 6, Sue has her IVR 320 to offer callers the option of having the communication system poll Sue's various communication devices in an attempt to find Sue, or to simply leave a message for her. Bob's IVR 320 offers callers a selection of options, including voice mail, email, and paging services, as does Terry's IVR 320.

A 911 emergency call recognition and forwarding feature 322 is also included in database 202. That is, upon dialing 911 or another known emergency telephone number, the caller is connected to an emergency services telephone number near the telephone from which they called. The SS7 database is used to find the emergency services telephone number that is near the caller. At the same time, the call may be recorded, and an indication of the location of the caller may be provided to the emergency services provider. This redundant, battery-backed, always-available emergency call recognition and forwarding feature 322 is in contrast to some internet telephones, which depend upon local power sources that may be unavailable during an emergency.

In addition, database 202 has a capability for storing Communications Assistance for Law Enforcement Act (CALEA) 323 information corresponding to each user, unlike some competing voice over IP technologies. CALEA essentially mandates that new forms of technology allow law enforcement officials to conduct authorized electronic surveillance. Upon receiving the required authorization from a court to conduct a wiretap of a user's telephone, PC, PDA and/or other communication device, the CALEA part of the database can store that authorization, in order to provide a copy of a communication to the authorized law enforcement agency, for example by connecting a wiretap at the same time that the communication is connected. In the example illustrated in FIG. 6, the CALEA 323 authorization corresponding to both Sue and Bob are inactive, whereas Terry's has an active authorization, indicating the ability to perform some form of wiretapping.

Although not shown, database 202 may include other features such as voice recognition software that can be employed by the user to access various functions including those shown in the database. The voice recognition software can maintain a record of a user's speech patterns for biometric identification and increased accuracy in recognizing the user's commands.

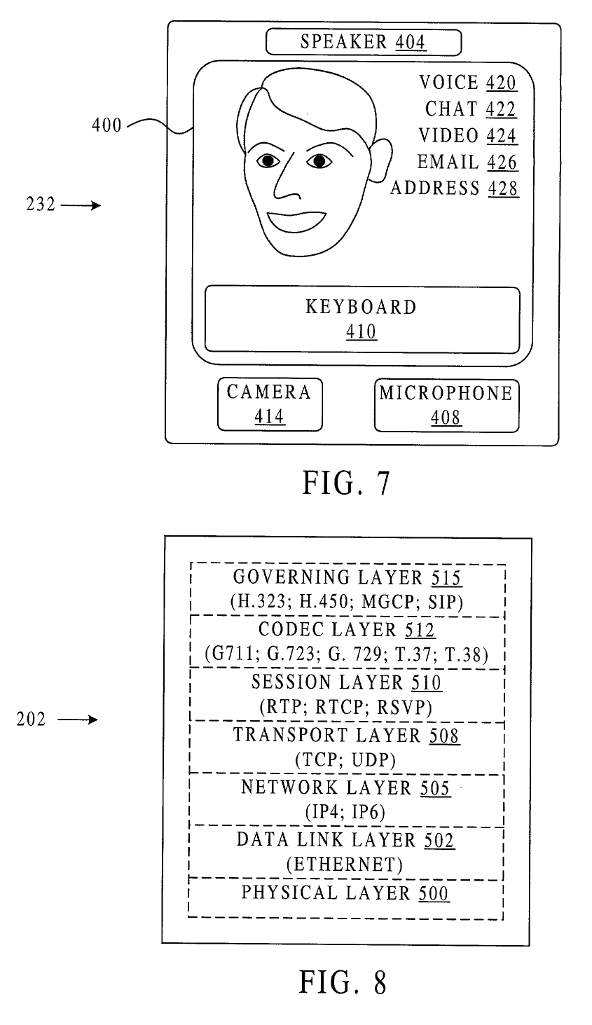

FIG. 7 shows a communication device such as PDA 232 with a display 400 that reflects the user's connection to web server 218, as interpreted by a web browser program of the PDA. The PDA has a speaker 404, a microphone 408, a keyboard 410 (which may be touch-screen) and a camera 414. The display offers links to several communication options for the user: voice 420, chat 422, video 424 and email 426. Using PDA 232, a user can connect to another user via packet manager 102, for example, by selecting a link to one of the communication options, which may be displayed as icons, and then entering the number of the person or selecting from a link to a list of addresses 428.

Once connected to a person, it is possible to select another communication option simply by clicking or touching the link to that option. Thus, for example, a first user can send an email to a second user, by first selecting the email link 426, then selecting the address link 428, and then selecting the second user's address. The second user happens to be online and, after reading the email and seeing that it was just sent, selects a chat function to respond. The chat response is received by the first user, who decides that he would like to communicate by voice, and selects the voice 420 icon. After speaking for a few minutes, the first and second users decide that they would rather communicate by video, and select the video icon 424.

Alternatively, more than one communication format can be used simultaneously, for example voice and text communication, so that the two users can speak to each other while working together on a text document that is displayed on both communication devices. As another example, more than two users can communicate simultaneously using one or more communication formats. The packet manager 102, in coordination with the web server 218, is able to seamlessly connect, disconnect and transfer between these various communication formats.

FIG. 8 shows various protocol layers of the gatekeeper 202. A physical layer 500 provides the transmission of bits between the gatekeeper and various devices, such as PCs and other digital communication devices, the SS7 database for telephone call control, internet gateways and routers. A data link layer 502, which may employ Ethernet protocols, controls reception and transmission of bits to and from higher protocol layers. The physical transmission and reception of bits as well as media access control of layers 500 and 502 may be performed by hardware chips.

A network layer 505 of gatekeeper 202 runs internet protocol (IP), which may in this embodiment be IP versions 4 or 6 (IP4 or IP6). For a transport layer 508, transport control protocol (TCP) or uniform datagram protocol (UDP) are employed, with TCP more frequently used for connection setup, teardown and monitoring, and UDP more frequently used for data transfer.

A session layer 510 of gatekeeper 202 runs realtime transport protocol (RTP) which, as mentioned above, is a protocol that runs over IP and supports “realtime” transmission of voice and video. An RTP packet rides on top of UDP and includes timestamping and synchronization information in its header for proper reassembly at the receiving end. Realtime transport control protocol (RTCP) is a companion protocol that is used to maintain QOS. RTP nodes analyze network conditions and periodically send each other RTCP packets that report on network congestion. Session layer 510 also runs reservation protocol (RSVP), which is a communications protocol that signals a router to reserve bandwidth for realtime transmission. RSVP is designed to clear a path for audio and video traffic and thereby reduce latency and jitter.

A codec layer 512 is included in the gatekeeper for handling various voice transmissions bit rates and compressions, such as G.711 for uncompressed voice at 64 kilobits per second (Kbps), G.723 at 32 Kbps and G.729 at 8 Kbps. Also supported are fax protocols such as T.37 and T.38 for use of fax within H.323. Although not shown in FIG. 8, the codec layer 512 can also contain video codecs, including H.261 and H.263. The codec layer 512 provides the gatekeeper with the ability to control a codec protocol of gateways such as gateway 130, 133, 205 and/or 225, so that a pair of gateways that are communicating have matching codec protocols.

A governing layer 515 of the gatekeeper 502 contains various high level protocols that may govern communication between various end user devices and over various networks including the PSTN and IP networks. The governing layer 515 includes H.323, an International Telecommunications Union (ITU) standard for realtime, interactive voice and videoconferencing over IP networks such as LAN 170 and the Internet 30. H.323 defines protocols by which any combination of voice, video and data can be transported over an IP network. H.450, which is also included in governing layer 515, specifies various messaging options in concert with H.323.

Governing layer 515 also includes Media Gateway Control Protocol (MGCP), which is a protocol for IP telephony from the Internet Engineering Task Force (IETF). Working in conjunction with the Gateway Location Protocol (GLP), MGCP enables a caller with a PSTN phone number to locate the destination device and establish a session. It provides the gateway-to-gateway interface for session initialization protocol (SIP), another protocol included in governing layer 515. SIP is a protocol that provides IP telephony services similar to H.323, but is less complex and uses less resources, making it suitable for very small portable devices. Thus governing layer 515 provides for a plurality of otherwise distinct protocols governing voice communications, and more than one of the distinct protocols may be used for a particular conversation.

The provision of all these various alternative and competing protocols in the governing layer 515 allows gatekeeper 202 to control and integrate a wide variety of communication devices and networks, so that end users can communicate via otherwise incompatible devices, networks and protocols that their communication may encounter.

Although we have focused on teaching the preferred embodiments of a system for handling diverse communication formats and communicating messages between various communication devices, other embodiments and modifications of this invention will be apparent to persons of ordinary skill in the art in view of these teachings. Therefore, this invention is limited only by the following claims, which include all such embodiments, modifications and equivalents when viewed in conjunction with the above specification and accompanying drawings.

1. A communication system comprising:
a plurality of user interface devices adapted to present information in a form discernible by humans, wherein a first of said user interface devices is configured to transmit and receive analog signals, and a second of said user interface devices is configured to transmit and receive digital signals,
first and second transmission lines respectively connected to said first and second user interface devices, with said first transmission line being adapted to carry said analog signals and coupled to a gateway configured to convert said analog signals to and from communication packets, and
a packet manager coupled to said first and second transmission lines and configured to control a plurality of communications formats including voice, fax, and email, said packet manager including a database containing data corresponding to a plurality of users and categorized in accordance with said formats, whereby said packet manager provides a mechanism for communication between said plurality of user interface devices.

2. The system of claim 1, wherein said packet manager is coupled to and interacts with a public switched telephone network database of telephone numbers.

3. The system of claim 1, wherein said packet manager includes a web site coupled to said database, said web site providing information to said second user interface device corresponding to one of said plurality of users.

4. The system of claim 1, wherein said packet manager includes a web site coupled to said database, said web site providing said information to said second user interface device regarding a connection between said second user interface device and a third of said user interface devices.

5. The system of claim 1, further comprising a web site coupled to said database and providing a web page displayable by said second user interface device, said web page including a plurality of links corresponding to a plurality of communication formats including voice, chat, video and email, wherein selecting one of said links sets up a communication connection for said second user interface device in accordance with one of said formats that corresponds to said one link.

6. The system of claim 1, further comprising a web site coupled to said database and providing a web page displayable by said second user interface device, said web page including links corresponding to a plurality of communication formats including voice, chat, video and email, wherein selecting one of said links switches a communication connection for said second user interface device from a first of said formats to a second of said formats that corresponds to said one link.

7. The system of claim 1, wherein said user interface devices include a third user interface device, said third user interface device being configured to transmit and receive analog signals and being separated from said first user interface device by a trunk having a length of at least 1000 kilometers, wherein voice communications between said first and third user interface devices are transmitted with a delay of less than 150 milliseconds.

8. A communication system comprising:
first and second user interface devices adapted to present information in a form discernible by humans, said first user interface device configured to transmit and receive analog signals,
first and second transmission lines respectively connected to said first and second user interface devices, said first transmission line configured to carry said analog signals,
a message center operably coupled to said first user interface device via said first transmission line,
a gateway respectively coupled to said first and second transmission lines and configured to convert said analog signals to and from packets of digital signals, with said digital signals carried on a dedicated transmission line connected to said gateway, and
a packet manager coupled to said gateway by said dedicated line and connected to an interstate trunk having at least one low-latency packet switch, said packet manager configured to route said packets to and from said first gateway, to and from said trunk, to and from said message center, and to and from the Internet.

9. The system of claim 8, wherein said packet manager includes a machine-readable program stored on a machine-readable medium, said program containing a plurality of distinct protocols governing voice communications, said packet manager employing at least two of said distinct protocols to provide voice communication between said first and second user interface devices.

10. The system of claim 8, wherein said trunk is coupled to a second gateway that is connected to said second user interface device, and voice communications between said first and second user interface devices are transmitted over a distance greater than 1000 kilometers with a delay of less than 150 milliseconds.

11. The system of claim 8, further comprising a web server coupled to said packet manager and to said second user interface device, said web server providing a web page displayable by said second user interface device, said web page including a plurality of links corresponding to a plurality of communication formats including voice, chat, video and email, wherein selecting one of said links sets up a communication connection for said second user interface device according to a format corresponding to said one link.

12. The system of claim 8, further comprising a web server coupled to said packet manager and to said second user interface device, said web server providing a web page displayable by said second user interface device, said web page including a plurality of links corresponding to a plurality of communication formats including voice, chat, video and email, wherein selecting one of said links switches a communication connection of said second user interface device from a first of said formats to a second of said formats, said second format corresponding to said one link.

13. The system of claim 8, wherein said packet manager includes a web site providing a web page displayable by said second user interface device, said web page including a plurality of links corresponding to a plurality of communication formats including voice, chat, video and email, wherein selecting one of said links sets up a communication connection for said second user interface device according to a format corresponding to said one link.

14. The system of claim 8, wherein said packet manager includes a web site providing a web page displayable by said second user interface device, said web page including a plurality of links corresponding to a plurality of communication formats including voice, chat, video and email, wherein selecting one of said links switches a communication connection for said second user interface device from a first of said formats to a second of said formats, said second format corresponding to said one link.

15. The system of claim 8, wherein said packet manager is coupled to and interacts with a public switched telephone network database of telephone numbers.

16. A communication system comprising:
a machine-readable program stored on a machine-readable medium, said program containing a plurality of distinct protocols governing voice communications, video communications and data communications, said program operable by a central processing unit to control communications between a plurality of user interface devices adapted to present information in a form discernible by humans, said user interface devices including a telephone, video communication device, facsimile machine, personal computer, personal digital assistant and cell phone.

17. The system of claim 16, further comprising a database stored on a computer-readable medium and accessible by said central processing unit, said database containing information regarding said user interface devices.

18. The system of claim 16, further comprising a web site controlled by said central processing unit operating said program, said web site coupled to at least one of said user interface devices and providing a web page displayable by said user interface device, said web page including a plurality of links corresponding to a plurality of communication formats including voice, chat, video and email, wherein selecting one of said links sets up a communication connection for said user interface device according to a format corresponding to said one link.

19. The system of claim 16, further comprising a web site controlled by said central processing unit operating said program, said web site coupled to at least one of said user interface devices and providing a web page displayable by said user interface device, said web page including a plurality of links corresponding to a plurality of communication formats including voice, chat, video and email, wherein selecting one of said links switches a communication connection for said user interface device from a first of said formats to a second of said formats, said second format corresponding to said one link.

20. The system of claim 16, wherein said program includes means for initiating a connection between at least two of said user interface devices.
